(19) United States
(12) Patent Application Publication
(10) Pub. No.: US 2021/0350331 A1
(43) Pub. Date: Nov. 11, 2021

(54) MODEL AND PURSE AMOUNT FOR ENHANCED HEALTH SAVINGS ACCOUNTS

(71) Applicant: Lane Health Inc., Haverford, PA (US)

(72) Inventors: Bradley Alan Gambill, Haverford, PA (US); Lev Peysekhman, Freehold, NJ (US)

(21) Appl. No.: 17/308,525

(22) Filed: May 5, 2021

Related U.S. Application Data
(60) Provisional application No. 63/021,342, filed on May 7, 2020.
(60) Provisional application No. 63/070,554, filed on Aug. 26, 2020.

(51) Int. Cl. G06Q 10/10; G06Q 10/06; G06Q 40/00; G06Q 40/02

(52) U.S. Cl. CPC G06Q 10/1057; G06Q 10/06393; G06Q 40/08; G06Q 40/125; G06Q 40/025; G06Q 10/1053

(57) ABSTRACT

Methods and systems may be associated with an enhanced Health Saving Account (“HSA”) offered by an employer to a plurality of employees. An advance limit calculation platform may access information in a member data store that contains information associated with the plurality of employees. The member data store may include, for each employee, an employee identifier, a communication address, and employment characteristics that were received from an employer human resources system. The advance limit calculation platform may then calculate, for each employee, an advance limit based on the employment characteristics (e.g., salary information, a date of hire, payroll deduction availability, a number of dependents, etc.). The system may then arrange to transmit, to each employee via the communication address and a distributed communication network, enhanced HSA information including the calculated advance limit. Moreover, embodiments may provide a scoring model and/or purse amount for the enhanced HSA.

### CROSS-REFERENCE TO RELATED APPLICATIONS

The present application claims the benefit of U.S. Provisional Patent Application No. 63/021,342, entitled “SYSTEMS AND METHODS ASSOCIATED WITH ENHANCED HEALTH SAVINGS ACCOUNTS” and filed May 7, 2020, and U.S. Provisional Patent Application No. 63/070,554, entitled “CREDIT SCORING MODEL AND PURSE AMOUNT FOR ENHANCED HEALTH SAVINGS ACCOUNTS” and filed Aug. 26, 2020. The entire content of those applications are incorporated herein by reference.

### BACKGROUND

The average employer sponsored High Deductible Health Plan (“HDHP”) has an employee only deductible of $2,400. At the same time, 75% of Americans cannot cover a surprise $1,000 expense leaving them unable to pay their medical bills. Thus, there may be a need to help employees enrolled in a HDHP avoid the pain and anxiety associated with expenses that are either unbudgeted or not yet funded through their Health Savings Account (“HSA”). If it could help employees pay their medical expenses through a simple “swipe and advance” program, a solution might eliminate barriers to care and reduce the stress associated with unexpected or unfunded medical bills. Implementing such a system might require, however, a way to predict risks associated with this type of help and/or ways for it to be implemented.

It would therefore be desirable to provide a scoring model and/or purse amount an enhanced HSA account for a computing environment in a secure, automatic, and efficient manner.

### SUMMARY

According to some embodiments, methods and systems may be associated with an enhanced Health Saving Account (“HSA”) offered by an employer to a plurality of employees. An advance limit calculation platform may access information in a member data store that contains information associated with the plurality of employees. The member data store may include, for each employee, an employee identifier, a communication address, and employment characteristics that were received from an employer human resources system. The advance limit calculation platform may then automatically calculate, for each employee, an advance limit based on the employment characteristics (e.g., salary information, a date of hire, payroll deduction availability, a number of dependents, etc.). According to some embodiments, the system may then arrange to transmit, to each employee via the communication address and a distributed communication network, enhanced HSA information including the calculated advance limit. Moreover, some embodiments may provide a scoring model and/or purse amount for the enhanced HSA.

Some embodiments comprise: means for accessing information in a member data store that contains information associated with a plurality of employees, including, for each employee, an employee identifier, a communication address, and employment characteristics that were received from an employer human resources system; means for automatically calculating, by an advance limit calculation platform for each employee, an advance limit based on the employment characteristics; and means for arranging to transmit, to each employee via the communication address and a distributed communication network, enhanced HSA information including the calculated advance limit. Moreover, some embodiments may provide means for a scoring model and/or purse amount for the enhanced HSA.

Some technical advantages of some embodiments disclosed herein are improved systems and methods to provide a scoring model and/or purse amount an enhanced HSA account for a computing environment in a secure, automatic, and efficient manner.

### BRIEF DESCRIPTION OF THE DRAWINGS

FIG. 1 is a high-level block diagram of a system in accordance with some embodiments.

FIG. 2 is a method according to some embodiments.

FIG. 3A is an enrollment information flow diagram in accordance with some embodiments.

FIG. 3B is another enrollment information flow diagram in accordance with other embodiments.

FIG. 4A is a granting advance information flow diagram according to some embodiments.

FIG. 4B illustrates creation of an advance and associated payments prior to each pay period according to some embodiments.

FIG. 5 is a receiving payment information flow diagram in accordance with some embodiments.

FIG. 6 is an employee termination information flow diagram according to some embodiments.

FIG. 7 is a request for increased advance limit information flow diagram in accordance with some embodiments.

FIG. 8 is a payment delinquency information flow diagram according to some embodiments.

FIG. 9A is a retrospective product flow in accordance with some embodiments.

FIG. 9B is another example of a retrospective product flow in accordance with some embodiments.

FIG. 10 shows retrospective product flows of cash diagram according to some embodiments.

FIG. 11 is a human machine interface display according to some embodiments.

FIG. 12 is an apparatus or platform according to some embodiments.

FIG. 13 is portion of a dependency configuration data store in accordance with some embodiments.

FIG. 14 illustrates a credit model according to some embodiments.

FIG. 15 is a credit model method in accordance with some embodiments.

FIG. 16 is a gap faced by many workers according to some embodiments.

FIG. 17 is a financial example in accordance with some embodiments.

FIG. 18 illustrates a purse for an enhanced HSA according to some embodiments.

FIG. 19 is a money flow timeline in accordance with some embodiments.

FIG. 20 illustrates segment risk underwriting according to some embodiments.

FIG. 21 is an optional process to assign advance limits to individual employees in accordance with some embodiments.

FIG. 22 is a turnover prediction process according to some embodiments.

FIG. 23 is an algorithm to set credit limits in accordance with some embodiments.

FIG. 24 is an employee turnover algorithm according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Note that healthcare costs are growing at rates that are unmanageable for many Americans and their employers. HDHPs were created to encourage members to make more considered healthcare treatment decisions, and research shows that they generally achieve that objective and reduce costs as a result. However, prior to meeting deductibles, cash-strapped members often forego care they truly need. And with 75% of Americans having household savings of $1,000 or less, people accustomed to the higher level of financial protection often afforded by a Preferred Provider Organization (“PPO”) or Health Maintenance Organization (“HMO”) hesitate to switch to HDHPs, even when the difference in premiums more than offsets the difference in deductible.

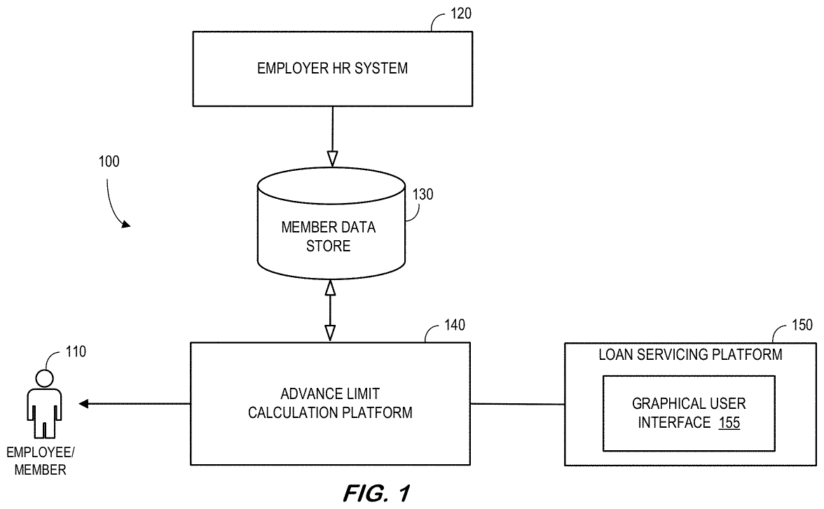

To avoid this, embodiments may provide an enhanced HSA account including a scoring model and/or purse amount for a computing environment in a secure, automatic, and efficient manner. For example, FIG. 1 is a high-level block diagram of a system 100 in accordance with some embodiments. The system 100 includes a member data store 130 that contains information (about an employee or member 110) that is a received from an employer's Human Resources (HR) system (e.g., salary information, date of hire, etc.). An advance limit calculation platform 140 may access information in the member data store 130 and automatically calculate an advance limit to be associated with a member's enhanced HSA. This advanced limit may be used by a loan servicing platform 150 and Graphical User Interface (“GUI”) to administer the enhanced HSA. This process might be performed automatically or be initiated via a command from a remote interface device. As used herein, the term “automatically” may refer to, for example, actions that can be performed with little or no human intervention.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The advance limit calculation platform 140 may store information into and/or retrieve information from various data stores (e.g., the member data store 130), which may be locally stored or reside remote from the advance limit calculation platform 140. Although a single advance limit calculation platform 140 and load servicing platform 150 are shown in FIG. 1, any number of such devices may be included. Moreover, various devices described herein might be combined according to embodiments of the present invention. For example, in some embodiments, the member data store 130 and the advance limit calculation platform 140 might comprise a single apparatus. Any of the system 100 functions may be performed by a constellation of networked apparatuses, such as in a distributed processing or cloud-based architecture.

A user or administrator may access the system 100 via a remote device (e.g., a Personal Computer (“PC”), tablet, or smartphone) to view information about and/or manage operational information in accordance with any of the embodiments described herein. In some cases, an interactive graphical user interface display may let an operator or administrator define and/or adjust certain parameters (e.g., to define advance rules or business logic) and/or provide or receive automatically generated recommendations or results from the system 100.

Some embodiments described herein provide a system 100 with a high level of convenience that provides a full suite of spending accounts, including HSA, Flexible Spending Account, (“FSA”), dependent care, and transportation using a single membership card. Embodiments may also offer peace of mind by leveraging account technology to give members access to a consumer health account platform to offer affordable health coverage, health treatment financing, and loans for treatments.

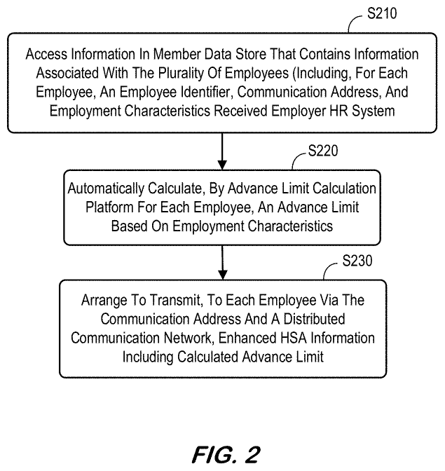

FIG. 2 is a method that might performed by some or all of the elements of the system 100 described with respect to FIG. 1. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, the system may access information in a member data store. The member data store may, for example, contain information associated with a plurality of employees, including, for each employee, an employee identifier, a communication address, and employment characteristics that were received from an employer human resources system. The communication address might be associated with, for example, an email address, a postal address, a telephone number, a text chat interface, a streaming video interface, etc. The employment characteristics might include, for example, salary information (employee or household salary, a date of hire, payroll deduction availability, a number of dependents, employer policies and preferences, governmental regulations, etc.

At S220, an advance limit calculation platform may automatically calculate, by for each employee, an advance limit based on the employment characteristics. The system may the arrange to transmit, to each employee via the communication address and a distributed communication network, enhanced HSA information including the calculated advance limit at S230.

An employee may then be registered as a member of the enhanced HSA, and an advance may be automatically activated when a member pays an HSA qualified bill in excess of an accumulated savings in their account (up to the advance limit for that member). The advance may then be automatically repaid in increments over a pre-determined time period. Note that a system administering the enhanced HSA may charge a pre-determined fee in connection with the advance (e.g., a $20 fee).

In this way, embodiments may meaningfully improve the quality and affordability of healthcare. Moreover, embodiments may mitigate financial risks and help people make the appropriate decisions regarding HDHPs via an enhanced HSA account. The member may be provided an advance limit when they enroll in the enhanced HSA. The advance might be, for example, repaid over one year (or less) through pre-tax HSA contributions deducted from payroll, thereby effectively saving the member over 30% on their medical bills. The enhanced HSA may also allow members with savings balances to earn more than the market rate of interest on HSA money they have saved. According to some embodiments, a system administering the enhanced HSA may bear some or all of the risk of default (instead of the employer) and may reduce the employer's payroll taxes when more medical expenses are paid with pre-tax HSA dollars.

According to some embodiments, the size of an advance made available to a member is not determined by a score, but is rather based on:
an ability to recover the advances through payroll deductions, including a deduction of the amount outstanding from their final paycheck if they leave the company,
tenure of employment,
income level (individual and/or household), and
a number of dependents.

After an advance is issued, the member might be charged no interest, but rather a per-payroll fee (e.g., $5 or $20) based on the advance balance outstanding. This fee might be paid with pre-tax dollars. Both the employee and employer may benefit from greater HDHP and HSA enrollment and utilization, higher employee satisfaction and engagement, reduced financial anxiety, income and payroll tax savings, etc.

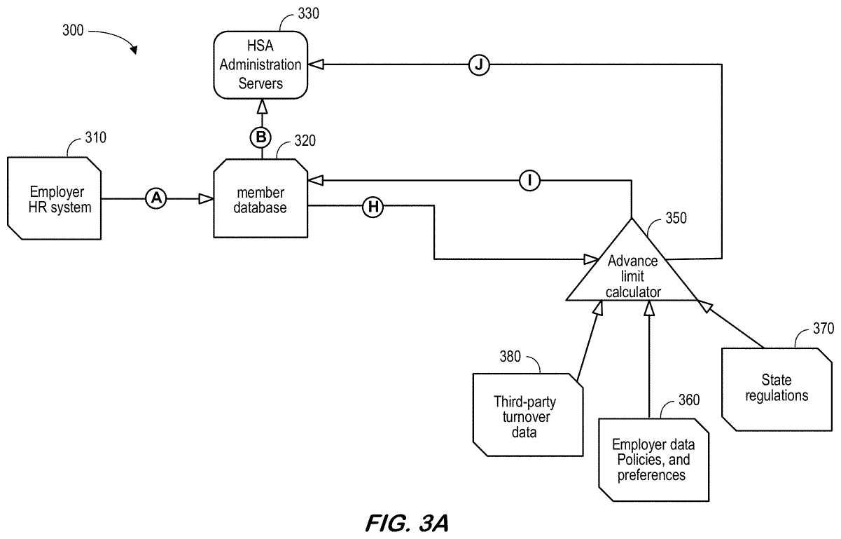

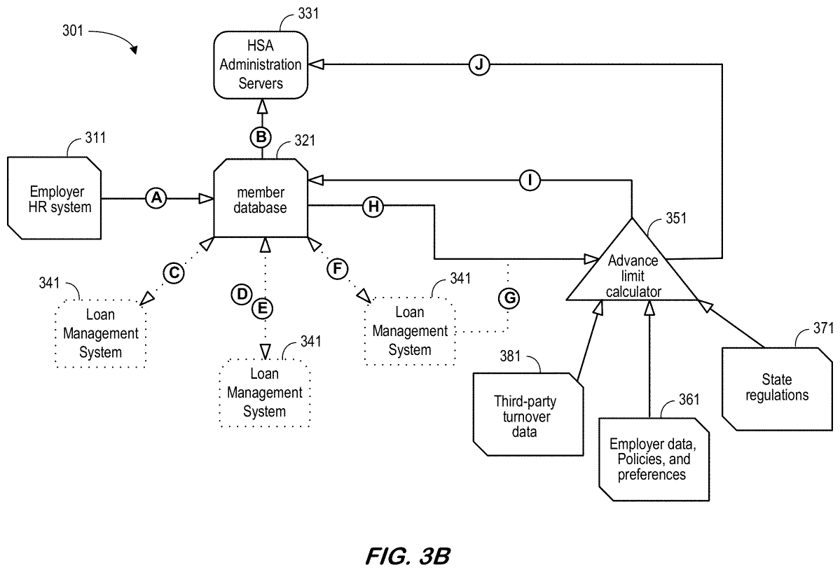

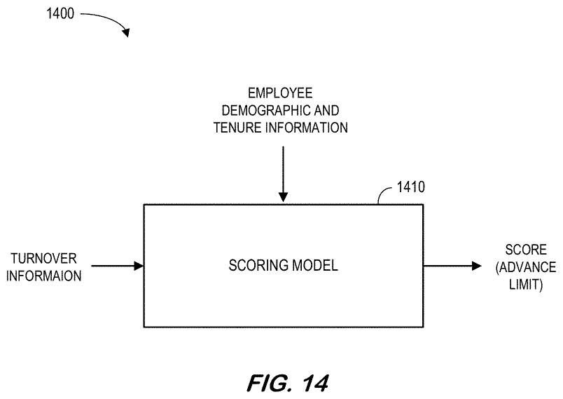

FIG. 3A is an enrollment information flow 300 in accordance with some embodiments. At (A), an employer HR system 310 may load information into a member database 320. At (B), an eligibility file might be uploaded from the member database to an HSA administration server 330 (e.g., via a Secure Shell (“SSH”) File Transfer Protocol (“SFTP”) transfer). An advance limit calculator 350 (e.g., associated with one or more credit algorithms or models as described with respect to FIGS. 14 through 22) may receive information from employer data, policies and preferences 360, state or other governmental regulations 370, turnover data 380 (e.g., from a third-party), etc. At (H), the advance limit calculator 350 may receive company information and/or dates of hire via an Application Programming Interface (“API”) from the member database 320. The advance limit calculator 350 may load a calculated advance limit into the member database 320 at (I) (e.g., via an API). The advance limit calculator 350 may also load the calculated advance limit to HSA administration server 330 (e.g., via a SFTP transfer). Note that in some embodiments, an administrator has the ability to review and approve the limit calculations before they are exported.

FIG. 3B is another enrollment information flow 301 in accordance with other embodiments. At (A), an employer HR system 311 may load information into a member database 321. At (B), an eligibility file might be uploaded from the member database to a HSA administration server 331 (e.g., via a Secure Shell (“SSH”) File Transfer Protocol (“SFTP”) transfer). Note that (C) through (G) in FIG. 3B are optional (as illustrated by dotted lines in FIG. 3B) and may be omitted in some embodiments. At (C) through (F), information may be exchanged with the member database and various loan management systems 341 to determine:
exchange a member/employee name,
member/employee identifier,
demographic information, and
a loan identifier to obtain a score.

At (G), an advance limit calculator 351 (e.g., associated with one or more credit algorithms or models as described with respect to FIGS. 14 through 22) may receive information from a loan management system 341, employer data, policies and preferences 361, state or other governmental regulations 371, turnover data 381 (e.g., from a third-party), etc. At (H), the advance limit calculator 351 may receive company information and/or dates of hire via an Application Programming Interface (“API”) from the member database 321. The advance limit calculator 351 may load a calculated advance limit into the member database 321 at (I) (e.g., via an API). The advance limit calculator 351 may also load the calculated advance limit to HSA administration server 331 (e.g., via a SFTP transfer). Note that in some embodiments, an administrator has the ability to review and approve the limit calculations before they are exported.

In this way, employers may have maximum flexibility to offer an enhanced HSA product as a standalone or bundled with other tax advantaged accounts (e.g., flexible spending, dependent care, and transportation accounts). The system may simplify implementation by working with an existing broker, consultant, and/or benefits administrator to easily integrate and exchange data with current systems. Moreover, employees may have access to a state-of-the-art web portal allowing them to view their balances, see their outstanding advances, and/or withdraw money to cover expenses that were not paid via their card. An employer may also receive reporting that helps them understand where there are opportunities to continue to help employees maximize the value of a benefits programs.

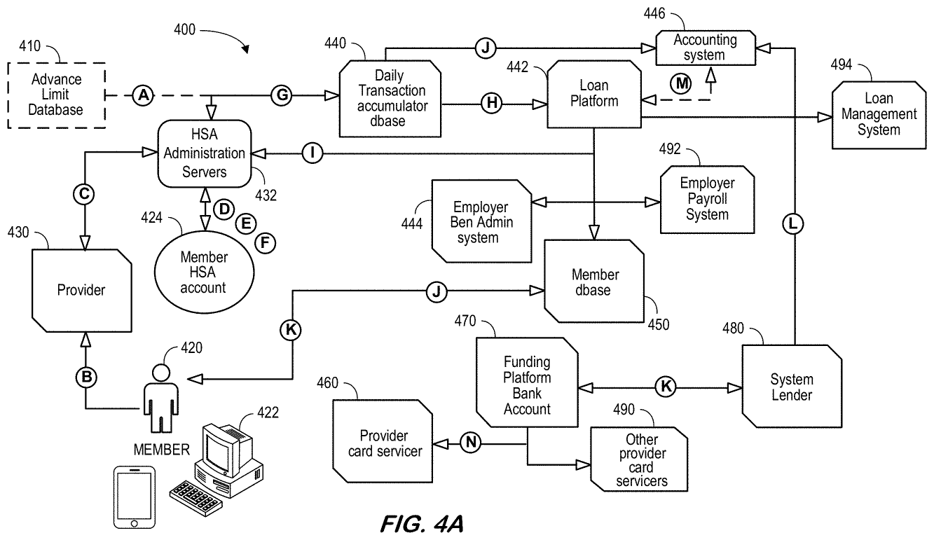

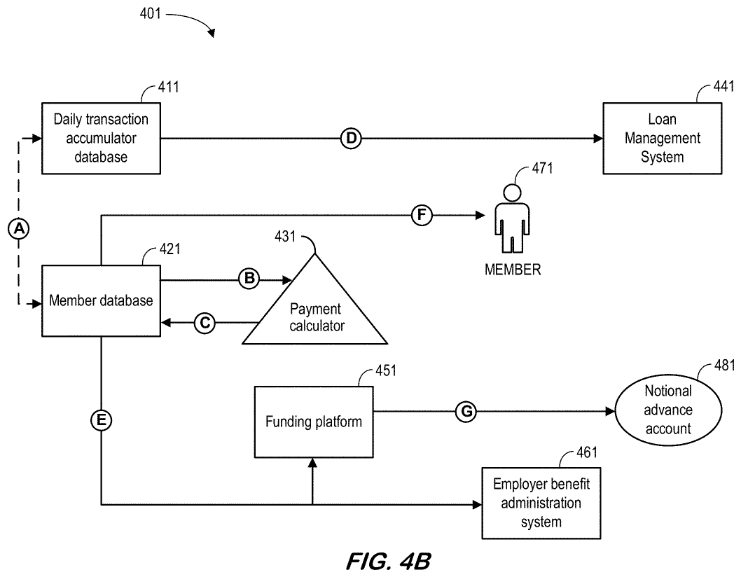

FIG. 4A is a granting advance information flow 400 according to some embodiments. At (A), an advance limit database 410 may send limit information to HSA administration servers 432 at enrollment. At (B), a member 420 and/or member device 422 may present a debit card or account number for a $1,000 payment to a provider 430. At (C), the provider exchanges information with a member HSA account 424 to request and receive approval for the $1,000 payment. At (D) through (F), the HSA administration server 432 and member HSA account exchange information to: check the member's balance and advance limit; find a $200 balance in his or her account; and confirm that the advance limit exceeds $800 (the difference between the current balance and the requested payment). At (G), the HSA administration server 432 sends a batch file with transaction at the end of the day (e.g. with all advances and contributions) to a daily transaction accumulation database 440. At (H), the daily transaction accumulation database 440 sends transactions accumulated between pay periods for each individual (so loans can be created) to a loan platform 442. Next, at (I), the loan platform 442 exchanges a payment amount and number of payments to HSA administration servers 432, an employer benefits administrator 444, and/or an employer payroll system 492. At (J), the daily transaction accumulation database 440 sends total debits (advances) and credits (repayments) for each day to an accounting system 446. In addition, a member database 450 asks for the purpose of the advance to a member 420 or member device 422 (e.g., via text or email). The member 420 responds to the member database 450 with the purpose at (K). Moreover, a funding platform bank account 470 may push/pull cash that is net of debits and/or credits for the day with a system lender. At (L), the system lender 480 sends confirmation of a net disbursement to the accounting system 446. At (M), a monthly reconciliation may be performed between the accounting system 446 and the loan platform 442. According to some embodiments, the loan platform 442 may also send information to a loan management system 494. At (N), the funding platform bank account 470, provider card servicer 460, and/or other provider card services 490 may exchange information to send $800 and settle the transaction.

FIG. 4B illustrates 401 creation of an advance and associated payments prior to each pay period according to some embodiments. At (A), a daily transaction accumulator database 411 and member database 421 may optionally stay synchronized with each daily transaction (as illustrated by the dashed line in FIG. 4B). At (B), the member database 421 may send amounts and payment terms for previously established advances and election amount to a payment calculator 431. At (C), the payment calculator 431 may return to the member database 421 a payment schedule and amounts for new advances and a new payment schedule and amounts (given previous advances and election amount). At (D), the daily transaction accumulator database 411 may send accumulated transactions since the last loan creation date to create a new “loan” at a loan management system 441. At (E), the member database 421 may send a deduction amount for the current period (done for each period over time) to a funding platform 451 and/or an employer benefit administration system 461. At (F), the member database 421 may send a notification that a new payment schedule is available (e.g., with a link to an appropriate website) to a member 471. The funding platform 451 may then update a notional advance account 481 balance and resulting credit limit at (G).

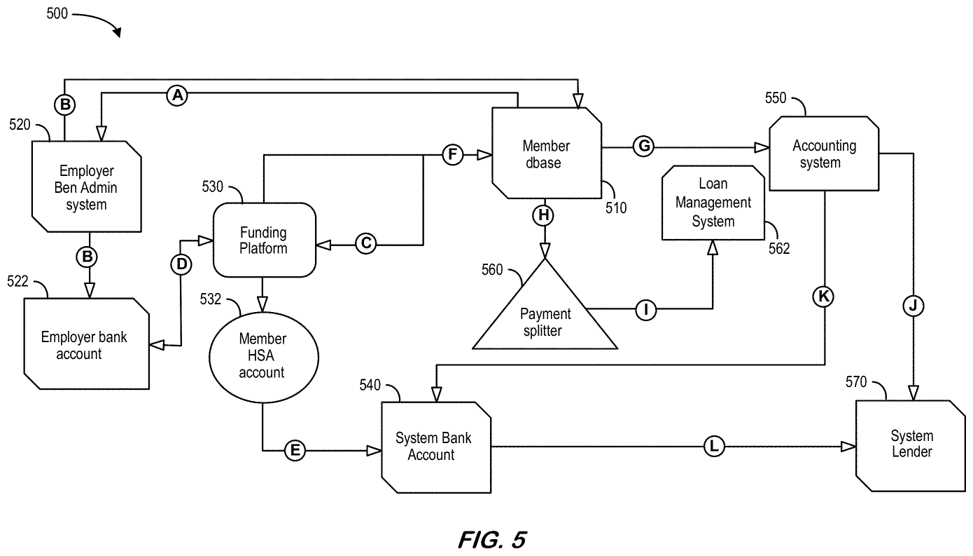

FIG. 5 is a receiving payment information flow 500 in accordance with some embodiments. At (A), a member database 510 sends deductions to an employer benefits administrative system 520 by a cutoff date (e.g., one or two days in advance of payroll date). At (B), the employer benefits administrative system 520 directs payment to HSAs to an employer bank account 522 (e.g., an account that funds flow from employer account). In addition, the employer benefits administrative system 520 sends a notification of actual deductions to the member database 510. At (C), the member database sends a notification of actual deduction to a funding platform 530. At (D), the funding platform 430 and employer bank account 522 exchange information to pull payment. At (E), a member HSA account 532 sends payment to a system bank account 540. At (F), a payment notification is sent (e.g., via SFTP) between the member database 510 and the funding platform 530. At (G), the member database sends a payment notification to an accounting system 550 (e.g., via an API). At (H), the member database 510 sends payment details by member to a payment splitter 560. The payment splitter 560 may then, for individuals with multiple loans split the payment into parts so each loan is properly credited, update a loan management system 562 at (I). At (J), the accounting system 550 may send a notification of payment (at the time of transaction and/or in a weekly summary) to a system lender 570. At (K), the accounting system 550 may send Automated Clearing House (“ACH”) instructions to send lender payment amount after calculating interest to the system bank account 540. At (L), the system bank account 540 sends principal and interest payment to the system lender 570.

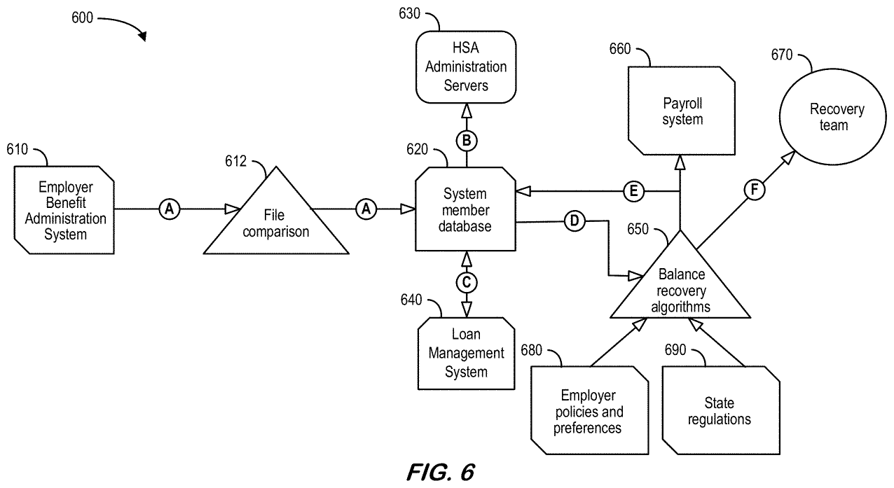

FIG. 6 is an employee termination information flow 600 according to some embodiments. At (A), an employer benefits administration system 610 may send an employee roster to a file comparison 612 (e.g., on a daily or weekly basis). Note that the system may either receive the full roster (and have to compare a current roster to a new roster to find terminations and additions) or a file with only additions and terminations. In either case, the terminations and additions may be provided to a system member database 620. At (B), the system member database 620 may notify HSA administration servers 630 about terminations (to turn off debit card). At (C), the system member database 620 may send an inquiry to a loan management system 640 to determine owed balances. At (D), the system member database 620 may send owed balances to balance recovery algorithms 650. The balance recovery algorithms 650 may determine whether state laws 690 and employer policies 680 allow the system to recover owed balance from a final paycheck. If yes, then the system confirms final paycheck to cover balance. If not (or if recovery from the final paycheck is not available for any other reason), then the system may turn this over to a “recovery team” 670 that tries to recover balances outside of payroll deductions. At (E), the balance recovery algorithm 650 sends deductions for the final paycheck as appropriate to a payroll system 660. At (F), the balance recovery algorithms 650 sends balances that can't be recovered in final paycheck to the recovery team 670.

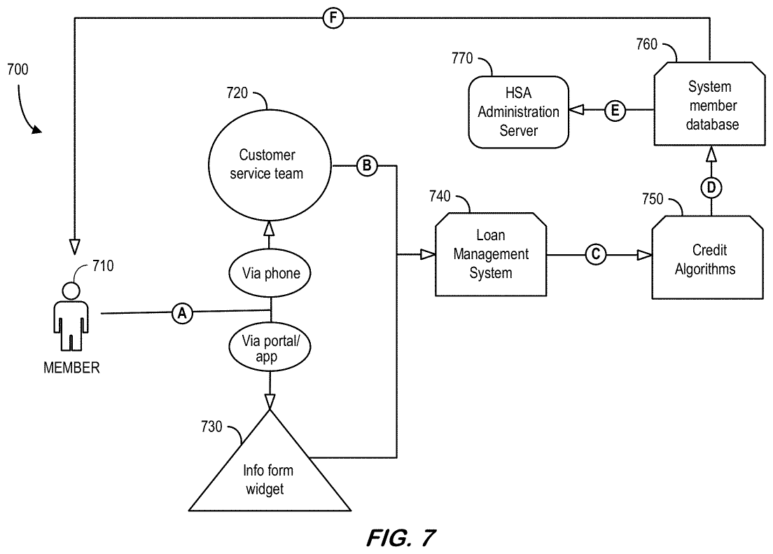

FIG. 7 is a request for increased advance limit information flow 700 in accordance with some embodiments. At (A), a member 710 sends a request for increase in advance limit to a customer service team 720 (e.g., via a telephone) or a widget 730 (e.g., via a portal or application). In either case, at (B) a loan management system 740 receives a member identifier to run a credit check. Note that the turnkey loan servicing platform 740 may run a credit report and update a probability of default. In some embodiments, the system may obtain a raw score and determine an estimated probability of default based on that score. At (C), the loan management system 740 sends updated information associated with potential default to one or more credit algorithms 750 (e.g., associated with an advance limit calculator and/or scoring model) to calculate a new advance limit. At (D), the credit algorithms 750 may send an updated limit to a system member database 760. At (E), the system member database 760 updates the limit by sending it to HSA administration servers 770.

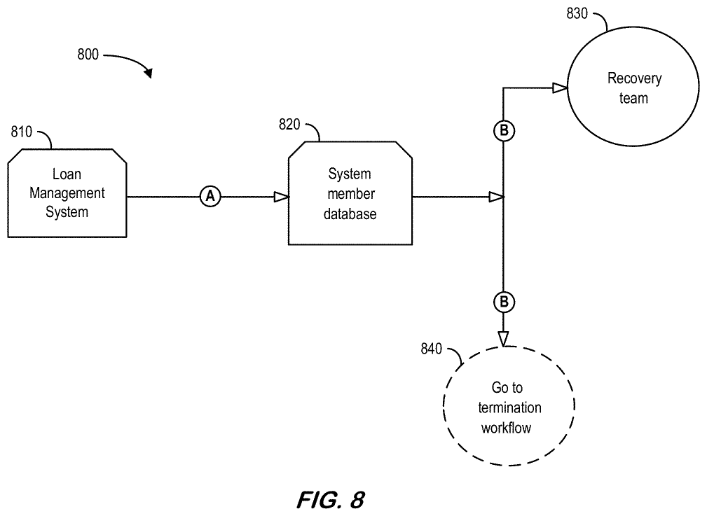

FIG. 8 is a payment delinquency information flow 800 according to some embodiments. At (A), a loan management system 810 sends a notification of delinquency to a system member database 820 (e.g., via an API). The system member database 820 may confirm whether there has been a termination. If there is no termination, the system member database 820 sends information to a recovery team 830. If there is a termination, the system member database 820 sends information to a termination workflow.

In some cases, people don't realize that they can reimburse themselves for prior year qualified medical expenses that were not reimbursed through their HSA—all the way back to the time they first opened their HSA. Today, employees can still take advantage of this opportunity, putting cash in their hands and reducing employer payroll taxes. To facilitate this, some embodiments described herein may provide a “retrospective HSA.” In such an approach, the system may help employees by identifying prior year HSA qualified medical bills paid with after-tax dollars. If the member agrees, the system may enable a simultaneous HSA contribution and reimbursement, thereby creating a tax savings benefit. As a result, the member may receive their usual paycheck plus the extra cash (which could be thousands of dollars).

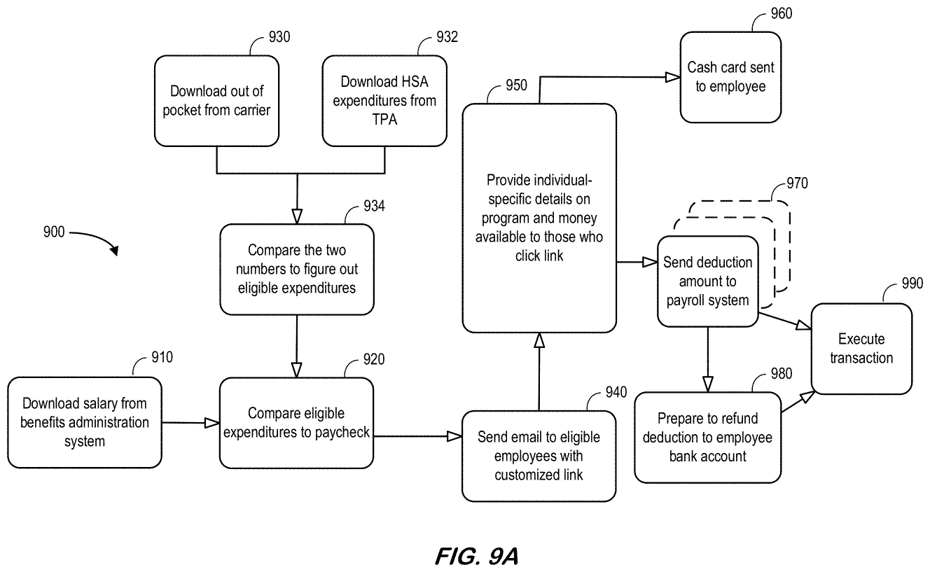

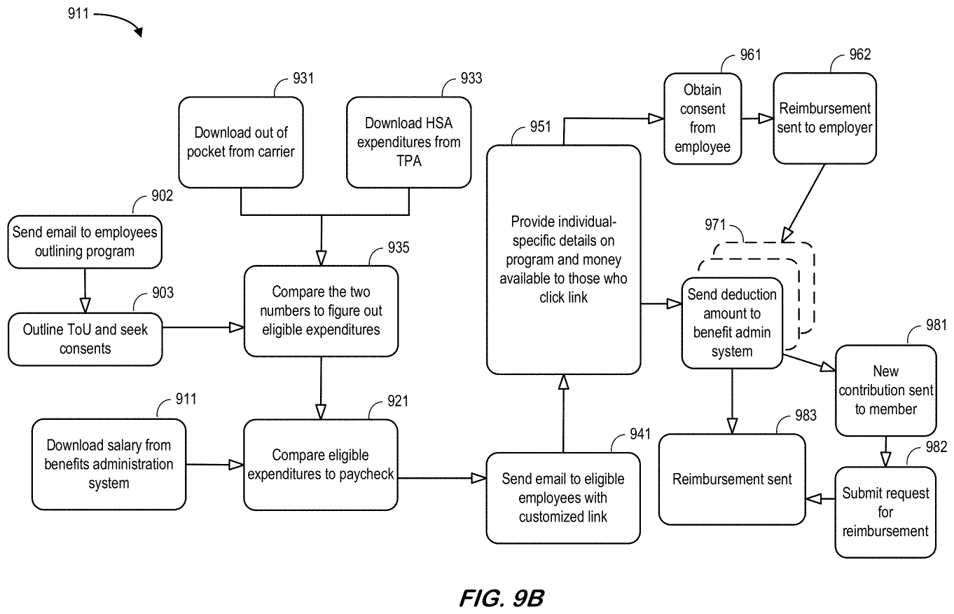

FIG. 9A is a retrospective product flow 900 in accordance with some embodiments. At 910, the system may download salary from benefits administration system. At 920, the system may compare eligible expenditures to a paycheck. Out Of Pocket (“OOP”) expenses may be downloaded from a carrier at 930, and HSA expenditures may be downloaded from a Third-Party Administrator (“TPA”) at 932. The emails may be compared at 934 to figure out eligible expenses. The system may then send an email to eligible employees with a customized link at 940. At 950, the system may provide individual-specific details on the programs and money available when the member clicks the link. A cash card may then be sent to the employee at 960. At 970, the system may send the deduction amount to a payroll system. The system may prepare to refund deduction to the employee bank account at 980 and execute the transaction at 990. Note that in some embodiments, the functions of FIG. 9A may instead be done from a portal (e.g., with or without emails having customizable links).

FIG. 9B is another example 901 of a retrospective product flow in accordance with some embodiments. At 902, the system may send an email to employees outline the program with a link to an appropriate website. At 903, the system may outline Terms of Use (“ToU”) and seek consent to pull HSA expenditures and OOP expenditures. At 911, the system may download salary from benefits administration system. At 921, the system may compare eligible expenditures to a paycheck (e.g., to ensure they don't exceed 50% of the paycheck). To do so, OOP expenses may be downloaded from a carrier at 931 (or they might be scraped from a service), and HSA expenditures may be downloaded from a Third-Party Administrator (“TPA”) at 933. The emails may be compared at 935 to figure out eligible expenses. The system may then send an email to eligible employees with a customized link at 941. At 951, the system may provide individual-specific details on the programs and money available when the member clicks the link. At 961, the system may obtain consent from the employee to change an HSA deduction and sign over reimbursement data. The reimbursement may then be sent at 962 to the employer so that it may be included in the employee's paycheck. At 971, the system may send the deduction amount to a benefit administration system. At 981, the new contribution may be sent to a member HSA account and a request may be submitted for reimbursement at 982 (e.g., from the HSA to the HSA provider). At 983, the reimbursement may be provided.

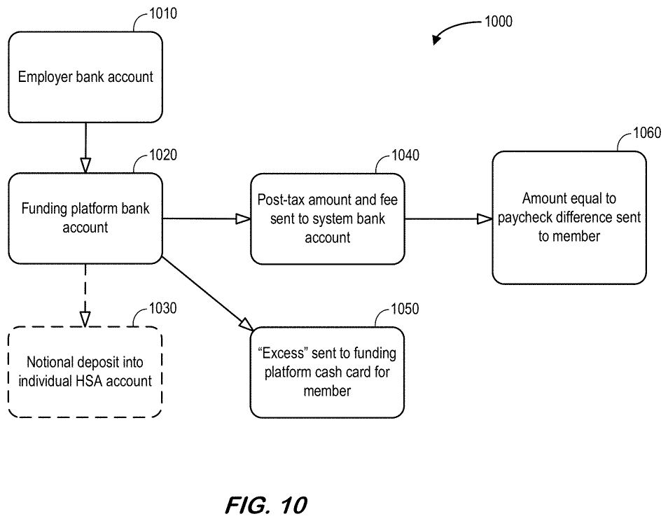

FIG. 10 shows retrospective product flows of cash 1000 according to some embodiments. Information from an employer bank account 1010 is provided to a funding platform bank account 1020. According to some embodiments, the funding platform bank account 1020 may be provided as a notional deposit into an individual HSA account 1030. The funding platform bank account 1020 may send information to a post-tax amount and fee sent to a system bank account 1040 and an amount equal to the paycheck difference may be sent to the member 1060. The funding platform bank account 1020 may also send “excess” information to a funding platform cash card for the member 1050.

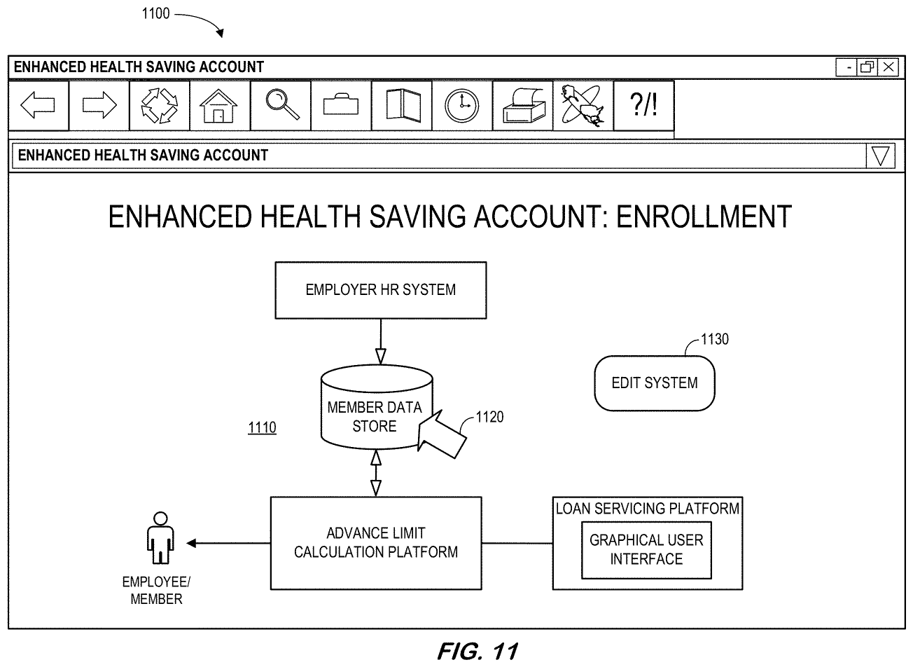

FIG. 11 is a human machine interface display 1100 in accordance with some embodiments. The display 1100 includes a graphical representation 1110 of an enhanced HSA enrollment system in accordance with any of the embodiments described herein. Selection of an element on the display 1100 (e.g., via a touchscreen or a computer pointer 1120) may result in display of a popup window containing more detailed information about that element and/or various options (e.g., to change advance rules and business logic in accordance with an employer preference, governmental regulations, etc.). Selection of an “Edit System” icon 1130 may also let an operator or administrator adjust the operation of the enhanced HSA enrollment system.

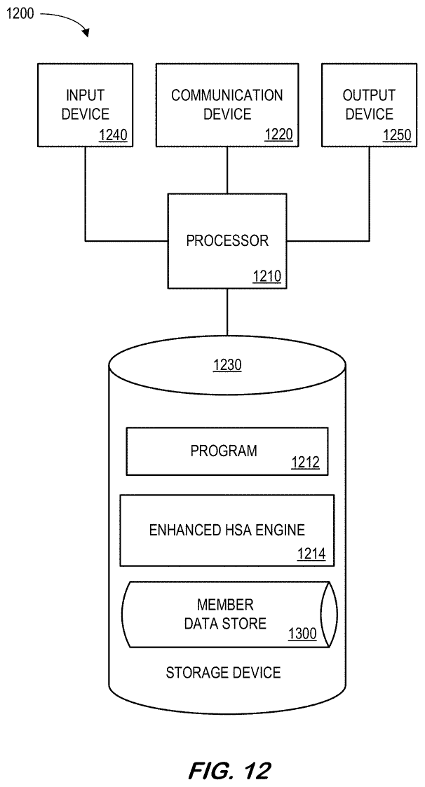

Note that the embodiments described herein may also be implemented using any number of different hardware configurations. For example, FIG. 12 is a block diagram of an apparatus or platform 1200 that may be, for example, associated with the system 100 of FIG. 1 (and/or any other system described herein). The platform 1200 comprises a processor 1210, such as one or more commercially available Central Processing Units (“CPUs”) in the form of one-chip microprocessors, coupled to a communication device 1220 configured to communicate via a communication network (not shown in FIG. 12). The communication device 1220 may be used to communicate, for example, with one or more remote user platforms, administrator platforms, etc. The platform 1200 further includes an input device 1240 (e.g., a computer mouse and/or keyboard to input advance rules and business logic in accordance with an employer preference, governmental regulations, etc.) and/or an output device 1250 (e.g., a computer monitor to render a display, transmit recommendations or alerts, and/or create reports about advance rates, potential alerts, etc.). According to some embodiments, a mobile device or PC may be used to exchange information with the platform 1200.

The processor 1210 also communicates with a storage device 1230. The storage device 1230 may comprise any appropriate information storage device, including combinations of magnetic storage devices (e.g., a hard disk drive), optical storage devices, mobile telephones, and/or semiconductor memory devices. The storage device 1230 stores a program 1212 and/or an enhanced HSA engine 1214 for controlling the processor 1210. The processor 1210 performs instructions of the programs 1212, 1214, and thereby operates in accordance with any of the embodiments described herein. For example, the processor 1210 may access information in a member data store 1300 that contains information associated with the plurality of employees. The processor 1210 may then calculate, for each employee, an advance limit based on the employment characteristics (e.g., salary information, a date of hire, payroll deduction availability, a number of dependents, etc.). According to some embodiments, the processor 1210 may then arrange to transmit, to each employee via the communication address and a distributed communication network, enhanced HSA information including the calculated advance limit.

The programs 1212, 1214 may be stored in a compressed, uncompiled and/or encrypted format. The programs 1212, 1214 may furthermore include other program elements, such as an operating system, clipboard application, a database management system, and/or device drivers used by the processor 1210 to interface with peripheral devices.

As used herein, information may be “received” by or “transmitted” to, for example: (i) the platform 1200 from another device; or (ii) a software application or module within the platform 1200 from another software application, module, or any other source.

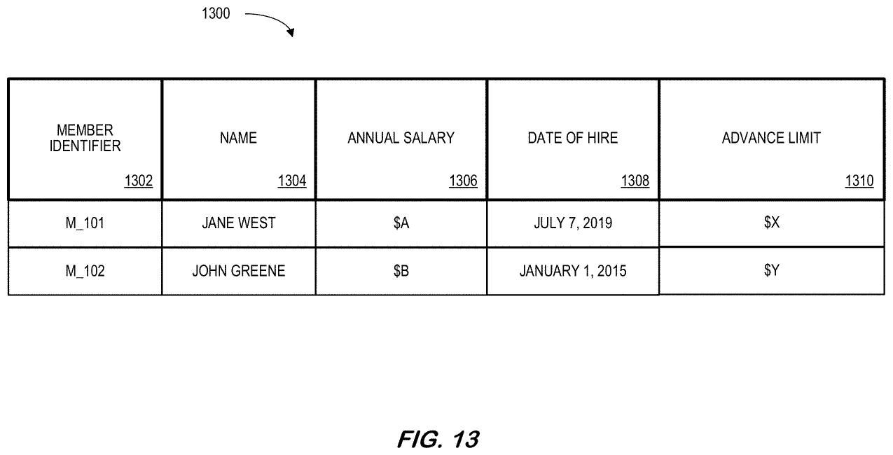

In some embodiments (such as the one shown in FIG. 12), the storage device 1230 further stores a member data store 1300. An example of a database that may be used in connection with the platform 1200 will now be described in detail with respect to FIG. 13. Note that the database described herein is only one example, and additional and/or different information may be stored therein. Moreover, various databases might be split or combined in accordance with any of the embodiments described herein.

Referring to FIG. 13, a table is shown that represents the member data store 1300 that may be stored at the platform 1200 according to some embodiments. The table may include, for example, entries associated with employees who participate in an enhanced HSA. The table may also define fields 1302, 1304, 1306, 1308, 1310 for each of the entries. The fields 1302, 1304, 1306, 1308, 1310 may, according to some embodiments, specify: a member identifier 1302, a name 1304, annual salary 1306, a date of hire 1308, and an advance limit 1310. The member data store 1300 may be created and updated, for example, when new employees are enrolled, employment characteristics are updated, etc.

The member identifier 1302 might be a unique alphanumeric label that is associated with an employee (with name 1304) who is participating in an enhanced HSA program. The annual salary 1306 (either individual or household) and date of hire 1308 (tenure information) m ay be used to calculate an appropriate advance limit 1310 for that member.

Thus, in addition to traditional account features, some enhanced HSA program embodiments described herein may offer:
automatic advances with a single card swipe regardless of current HSA account funding,
up to twelve months for advance repayment (with advances repaid with pre-tax dollars),
payroll tax savings for employers, and/or
limited risk to an employer (the enhanced HSA may instead bear the credit risk).
   Moreover, during implementation employers may take advantage of retrospective solution embodiments that let members recoup tax savings for prior year medical bills (creating an immediate cash benefit to both employees and employers).

FIG. 14 illustrates a system 1400 with a scoring model 1410 according to some embodiments. The scoring model 1410 may receive turnover information (e.g., an industry turnover rate and/or a company turnover rate) along with employee demographic information (e.g., tenure and/or gender). As will be described, the scoring model 1410 may then output a score or grade associated with an advance limit for an enhanced HSA.

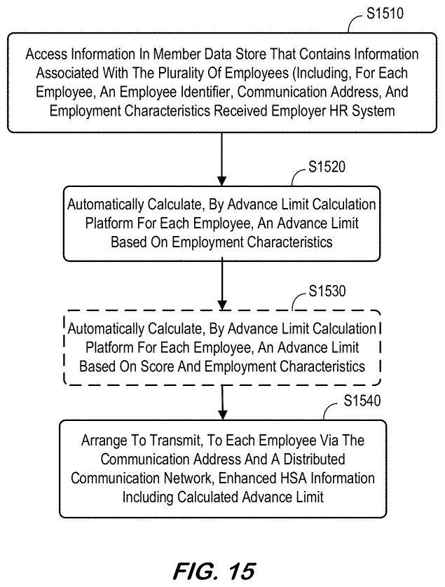

FIG. 15 is a credit model method in accordance with some embodiments. At S1510, the system may access information in a member data store. The member data store may, for example, contain information associated with a plurality of employees, including, for each employee, an employee identifier, a communication address, and employment characteristics that were received from an employer human resources system. The communication address might be associated with, for example, an email address, a postal address, a telephone number, a text chat interface, a streaming video interface, etc. The employment characteristics might include, for example, salary information (employee or household salary, a date of hire, payroll deduction availability, a number of dependents, employer policies and preferences, governmental regulations, etc.)

At S1520, the system may compute score information using a score model and turnover information (e.g., an industry turnover rate and/or a company turnover rate). At S1530, an advance limit calculation platform may automatically calculate, by for each employee, an advance limit based on score information and employment characteristics (e.g., demographic information such as tenure and/or gender). Note that S1530 is an optional step (as illustrated by a dashed line in FIG. 15), and some embodiments may instead provide credit without using a score check. The system may the arrange to transmit, to each employee via the communication address and a distributed communication network, enhanced HSA information including the calculated advance limit at S1540. According to some embodiments, the system may then attempt to access HSA funds of a particular employee. If sufficient HSA funds are not available, the system may access a purse amount, associated with the calculated advance limit, of that particular employee.

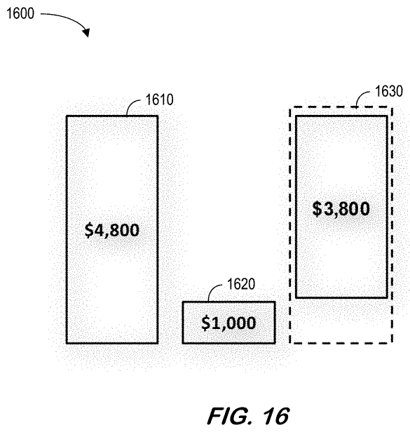

Up to fifty million Americans are enrolled in High Deductible Health Plans (“HDHPs”) and many of those people struggle to pay for healthcare. FIG. 16 illustrates 1600 a gap faced by many workers according to some embodiments. The $4,800 amount 1610 is an average HDHP family deductible. The $1,000 amount 1620 is amount of savings that many Americans (up to 69%) are unable to maintain. The $3,800 amount 1630 represents the gap between what they can afford to pay and the healthcare cost they may face, leading to financial hardship or delayed care (which may, of course, increase healthcare costs in the long run).

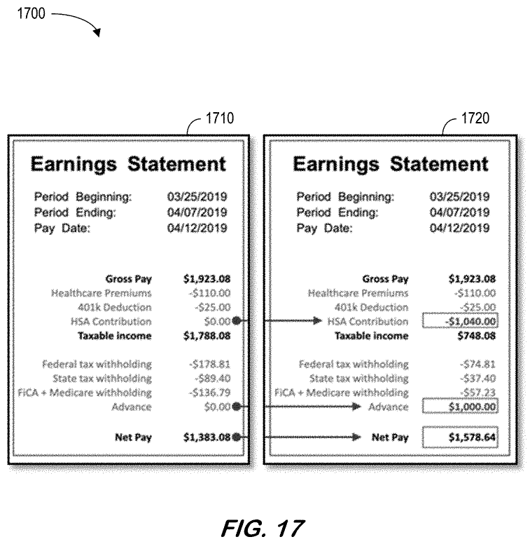

Some embodiments utilize payments through pre-tax payroll deductions over twelve months. Consider FIG. 17, which is a financial example 1700 in accordance with some embodiments. The example assumes $50,000 gross pay, 26 pay periods, and a 15% income tax rate. A first statement 1710 shows a $0 HSA contribution, a $ advance, and a net pay of $1,383.08. A second statement 1720, in contrast, shows a $1,040 HSA contribution, a $1,000 advance, and a net pay of $1,578.64. Note that because the Internal Revenue Service (“IRS”) allows expenses previously paid with post-tax dollars to be reimbursed with pre-tax dollars, there may be an immediate opportunity for most people using an HSA to increase take-home pay over one or more paychecks. Moreover, in some cases the employer may also save 7.65% in payroll taxes.

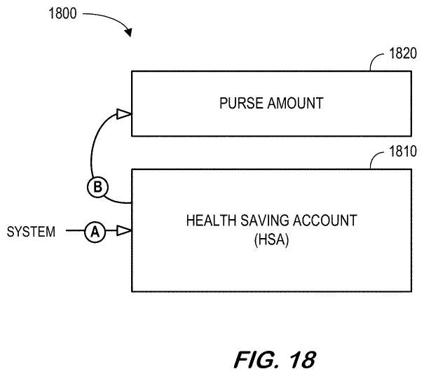

According to some embodiments, HSA advances may be automatically activated when needed. For example, FIG. 18 illustrates 1800 a system 1800 for an enhanced HSA according to some embodiments. At (A), the system may initially attempt to access HSA funds 1810 of a particular employee. If sufficient HSA funds 1810 are not available, the system may automatically access a purse amount 1820, associated with the calculated advance limit, of that particular employee at (B). The new “purse” amount 1820 on top of the HSA account 1810 represents a notional amount that the system is willing to loan to people. When an employee or dependent swipes the HSA card, the system first checks for funds available in the HSA account 1810 and if those are insufficient, the card processor taps into this additional purse amount 1820 to clear transactions.

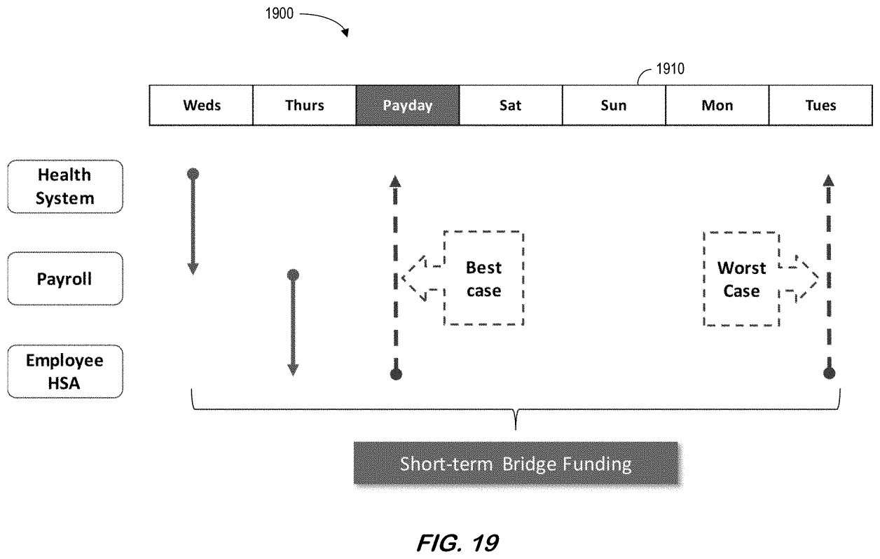

FIG. 19 is a money flow timeline 1900 in accordance with some embodiments. The timeline shows the days 1910 on which funds may flow from a health system to payroll (Wednesday) and then from payroll to an employee's HSA (Thursday). In a best-case scenario, funds may be returned the next day (Friday) while in a worst-case scenario it may take until next Tuesday. This period of time may require short-term bridge funding.

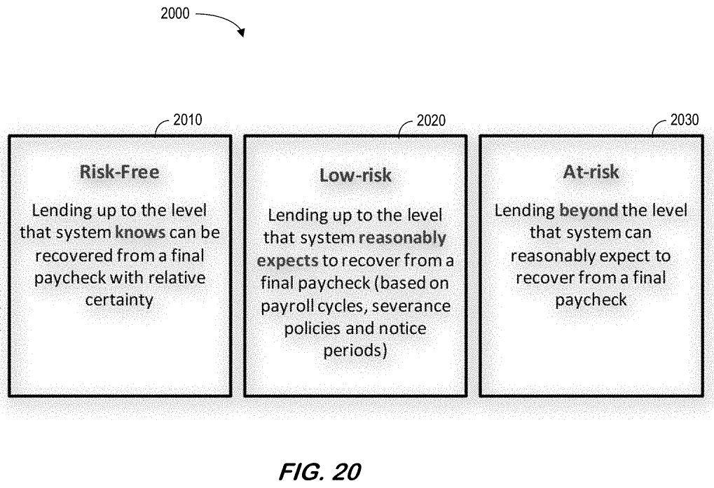

According to some embodiments, risk may be segmented into three distinct tiers or “buckets.” For example, FIG. 20 illustrates 2000 segment risk underwriting according to some embodiments. A first bucket 2010 may represent a “risk free” tier with lending up to the level that the system knows can be recovered from a final paycheck with relative certainty. A second bucket 2020 may represent a “low free” tier with lending up to the level that the system reasonably expects to recover from a final paycheck (based on payroll cycles, severance policies, notice periods, etc.). A third bucket 2030 may represent an “at-risk” tier with lending beyond the level that the system can reasonably expect to recover from a final paycheck.

Note that the increasing risk may be almost entirely driven by likelihood of termination (either voluntary or involuntary). The risk may be primarily mitigated by the system's ability to recover amounts due from an employee's last paycheck. This amount is expected, at a minimum, to be worth 7-10 days of payroll given the usual lag between payroll dates and payroll cycles. Additional amounts could be recovered from company-specific policies such as extended notice periods, Paid Time Off (“PTO”), sick-day payouts, severance, etc. The credit-model may thus become a function of two things—salary and probability of turnover. The credit-model may also become a key input into a sophisticated simulation model that gauges the potential performance of a portfolio of advances.

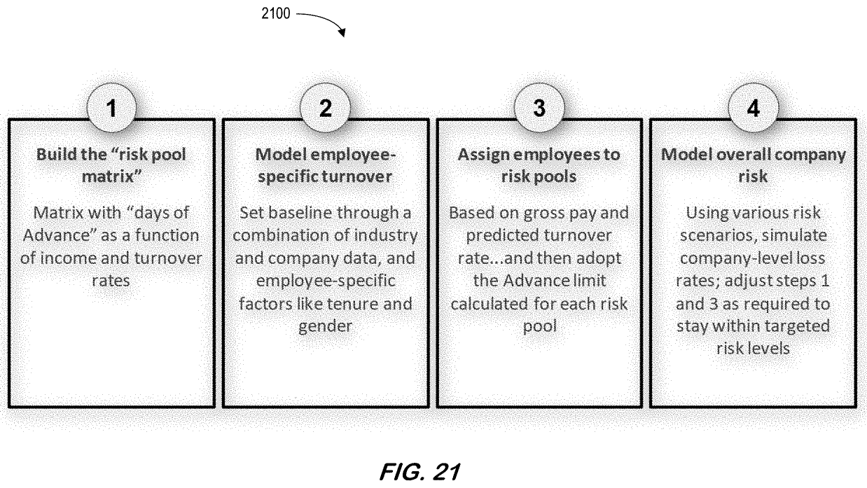

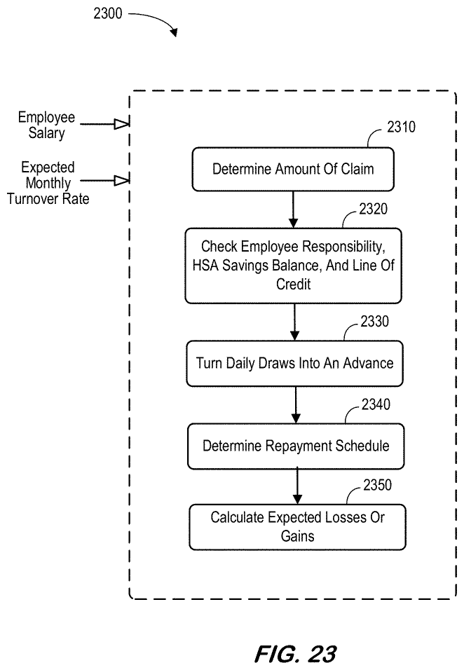

FIG. 21 is an optional four-step process 2100 to assign advance limits to individual employees in accordance with some embodiments. Note that other embodiments may instead use an algorithm to set credit limits such as one described in connection with FIG. 23. In a first step, the system may create company-specific risk pools that will define advance limits as the maximum number of days of gross salary that is available to be advanced before hitting a specified targeted loss rate. Advance limits may be calculated for each specific salary band (e.g., $30,000 to $130,000) and monthly probability of termination (e.g., 1% to 12%). In order to get to this output, each risk pool box (defined as a unique salary and monthly probability of termination) may go through a multi-variable simulation that utilizes the following inputs to create a set of man thousands off profiles. As used herein, the term “profile” may refer to a specific salary, probability of termination, and plan type (individual vs. family). Each profile may then be assigned a termination date (which could also be zero meaning no termination) using a Monte Carlo simulation. Inputs into the simulation may be a series of monthly termination probabilities and a random number generator. The number of periods may be adjusted based on a company's payroll schedule (e.g., there are 52 bi-weekly pay periods in a 24-month time horizon that captures an entire cohort's advance activity). Advances may be made throughout the calendar year with a 12-month payment term, so the last loans made in December of year 1 are paid off by December of year 2, hence the 24-month outlook in the model. In this version, there would be 52 periods upon which an employee can terminate. Separately, the model may assign each profile one of a thousand different medical use cases that tracks daily expenses throughout an entire 365-day period.

Independent of these variables, each profile is then assigned a likely HSA contribution given a known distribution of how HSA accounts are funded and capped at the IRS limits for family and individual contribution amounts (less the employer contribution amount). The system may then capture plan specific information (deductibles, employer HSA contribution amounts and timing, payroll policies, etc.) and calculate for each of the thousands of profiles the “need” for an advance. The “need” is defined as the gap between the employee's out of pocket amount due for a medical expense and their current HSA balance.

An Employee cost share may be calculated using the plan design cost-sharing formula (co-insurance, deductible threshold, and max-out-of-pocket threshold). An HSA balance is the daily remaining portion in the HSA account calculated as the accumulated employer and employee contributions less the employee's accumulated out of pocket expenses. When the HSA balance is zero, this triggers the need for an HSA advance to fill the gap. Note that the need for an advance does not automatically mean the entire amount is available for advance. In some embodiments, there are two limits to the advance needed that will ultimately define the advance given or provided. The two factors are the lower of (1) the IRS HSA contribution limit or (2) the set advance limit.

In the Risk Pool simulation, the Advance Limit ranges from 8-days to 28-days of gross salary. The model runs through all 21 scenarios adjusting each output for each of the thousands of profiles by changing the advance limit from 8-days to 28-days in one-day increments. Loss may be calculated for each scenario as the total amount unrecovered divided by total amount advanced. As used herein, the term “unrecovered” may refer to a portion of each profile's unpaid advanced amount up to the moment of separation less any amount recovered from a final paycheck. The term “total advanced” may refer to the sum of total advances given to each profile up to each profile's moment of separation and limited based on the lower of the (i) the needed advance, (ii) the IRS limit less all realized and planned annual HSA contributions and (iii) the advance limit.

As a result, each risk pool box may have the summation of all losses for each of the thousands of profiles, given each incremental day of advance limit increase. After all 21 scenarios (8-days to 28-days) are captured, the model may look back at all calculated loss rates in each of the 21 scenarios days of advance limits to identify the maximum days of advance that can be given before the loss rate exceeds a predetermined target loss rate. The resulting output is a matrix with salary bands on one axis and average monthly defaults on the other axis and maximum days of advance in each risk pool box.

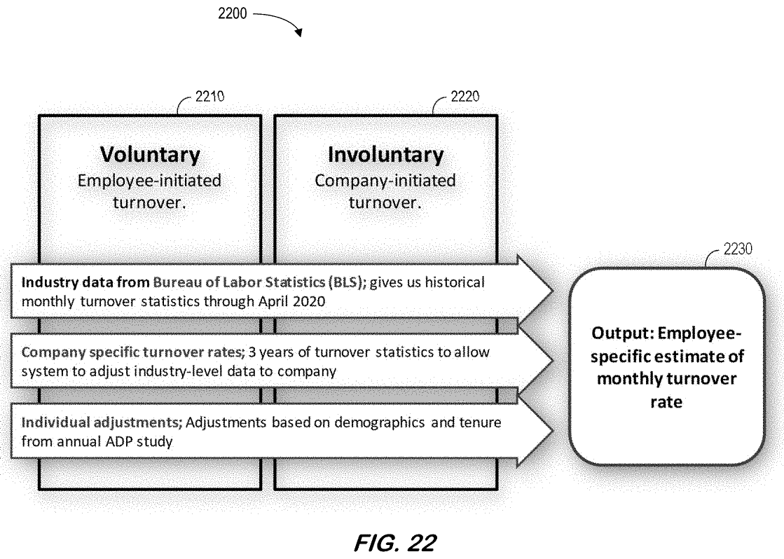

Now that the system has established how much it is advancing to each risk pool, in a second step the system may assign or “slot” employees into the right pool. Slotting employees correctly becomes a function of predicting their likely probability of turnover since we know with certainty what their salary band is going to be. To do that, the system may look at termination as two components as illustrated 2200 in FIG. 22: (1) voluntary 2210 (which is an employee leaving on their own) and (2) involuntary 2220 (which is essentially being let go or fired). The system may, according to some embodiments, triangulate several sources of data to perform this task and create an output 2230.

Referring again to FIG. 21, The Bureau of Labor Statistics (“BLS”) tracks monthly turnover by industry and company size (dating back to December 2000) and is updated monthly with a two-month lag. The system may capture monthly turnover data and view any combination of 24-months during the past 120-months as a potential scenario of what a future 24-month period could look like. For example, the system can look at the consecutive 24-months with the lowest average turnover or the highest average turnover. The system can also construct 24-month scenarios where the period goes from worst to best back to worst (or vice versa, going from worst to best to worst) and any other possible combination. Using these potential industry-derived future monthly turnover scenarios, the system may create a basis for what the future turnover might be at any one company within that industry.

The system may also look at company-specific turnover rates (e.g., for the past 3-years) to determine if the employer has higher or lower turnover relative to the industry. The system compares a company's historical turnover rates with industry turnover rates for the same periods. The outcome of this analysis creates a multiplier (e.g., 1.1× to denote a company with 10% higher historical turnover relative to the industry average) for that employer. This multiplier then becomes a proxy that captures the additional implied involuntary turnover risk specific to the employer.

Then, below the employer-level the system might look at the individual employee profile and assign risk multipliers based on the employee's tenure and gender (two highly correlated factors that predict potential turnover based on extensive studies). This multiplier becomes a proxy that captures the additional voluntary turnover specific to each employee.

A third step may use each employee's turnover probability and salary to assign each employee to a unique risk pool to determine an appropriate advance limit. At this point, the system may have a full employee roster and, next to each employee, an initial advance limit that they will be offered. In a fourth step, to further stress test the portfolio and simulate performance, the system run another Monte Carlo simulation model that mimics the process that was used to determine risk pool outputs, but instead of forcing a specific salary and turnover probability input, the simulation may use the employee's specific profile to rerun the same scenario and summarize the losses. This then creates a feedback loop that lets the system recalibrate assumptions made in the first two steps and re-run the models to mitigate against outlier scenarios.

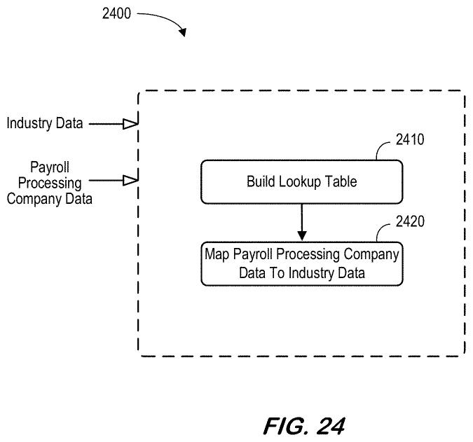

Some embodiments may be associated with an algorithm to set credit limits. FIG. 23 is an algorithm 2300 to set credit limits in accordance with some embodiments. Such an algorithm 2300 may be used to determine the credit limit provided to each employee in a client organization. The primary algorithm 2300 inputs may include employee salary and an expected monthly turnover rate (described in connection with FIG. 24). Other determinants may include the client's payroll cycle, health insurance plan design and expected HSA contributions by both the employer and employee.

According to some embodiments, the algorithm 2300 is probabilistic. Given the inputs, and a high use claims experience, it calculates the expected gains and losses for each of 761 straight days (which is one year of Advances, an additional year and 1 month to repay them—the additional one month may be necessary because draws occurring in the last 14 days of a year become advances first month of the following year). These gains and losses are based on the probability that the employee remains employed and sums those numbers across all 761 days to determine net cash for the year for that employee. Unlike a simulation, the algorithm 2300 is not calculating an expected experience for any given single employee. Rather, it is calculating the expected average result for an employee given large number of employees who look the same in terms of salary, expected turnover rate, health plan design, HSA contributions, and claims experience. The algorithm 2300, using a spreadsheet application data table, may then calculate the expected net cash position for each of 100 potential credit limits.

The algorithm 2300 calculates two parallel sets of numbers. The first set is expected performance assuming the employee remains employed throughout the entire period. The second set adjusts those numbers for the probability that the employee terminates at some point throughout the period, based on the turnover probability provided to the algorithm. For each day, the algorithm 2300 determines how much of the proposed credit line is likely to be used. To do so, it first determines the amount of the claim (if any) at 2310. The algorithm 2300 uses the same claims experience for every employee, and the claims experience modeled may, for example, represent $168,000 in claims over the course of one year. The algorithm 2300 then calculates the employee responsibility for that claim based on progress in meeting deductible and maximum out of pocket cost. If the employee has no responsibility, there is no need to draw against the credit line. If the employee does bear some responsibility, the algorithm 2300 then checks whether the HSA savings balance is adequate to cover the employee claim responsibility. If the savings balance is adequate to cover the employee's portion of the claim, there is no need to draw against the credit line. If not, the algorithm 2300 then checks whether the employee has already utilized the full line of credit. If not, the algorithm 2300 creates a draw that equals the minimum of the credit capacity remaining against the line of credit and remaining patient responsibility (after the HSA savings balance, if any, is exhausted). With this step completed the draw has now been determined for any given day. Draws are accumulated across all days to keep a running balance of money that has been disbursed.

The next task for the algorithm 2300 is to turn daily draws into an advance at 2330. To do so, the algorithm 2300 checks whether the current day is a statement date. The statement dates occur 14 days prior to a pay date, and pay dates are determined by the client's payroll cycle. On the statement date, the advance balance is determined by accumulating draws that have occurred since the last statement date. With the advance created, the algorithm 2300 must now determine the repayment schedule at 2340. Repayments may include principal, an origination fee (e.g., 5% of the original advance principal), and a periodic finance fee. The repayment schedule may vary based on payroll cycle:
52 pay periods: Two weeks after the advance is established the origination fee is drawn. Two weeks after that, the principal repayments begin and continue to be drawn every two weeks for 50 weeks. The amount of each principal repayment is advance amount divided by 25.
26 pay periods: Two weeks after the advance is established the original fee is drawn. Two weeks after that, the principal repayments begin and continue to be drawn every two weeks for 50 weeks. The amount of each principal repayment is advance amount divided by 25.
24 pay periods: Two weeks after the advance is established the origination fee is drawn. The principal repayments begin on the next pay date, which is either the 15th or last day of the month and continue to be drawn twice per month for the next 11.5 months. The amount of each principal repayment is advance amount divided by 23.
12 pay periods: Two weeks after the advance is established the origination fee is drawn along with a partial principal payment. For the next 11 months, principal repayments are drawn at the end of each month (or on the relevant pay date during the month). Payments are determined by summing the origination fee and total principal and dividing that number by 12. The first payment includes 100% of the origination fee and a principal repayment of 3.75% of the original principal balance. The next 11 principal payments represent 8.75% of the original principal balance.

Note that these repayment calculations may be subject to minimums. For each advance, the minimum payment may be, for example, $3 per pay period. In aggregate, the minimum payment across all advances may be $10. The algorithm 2300 accurately reflects these minimums when determining the repayment schedule for each advance.

A periodic finance fee may be calculated based on the average daily balance of a specific advance during the previous 75-day period. A tiered approach for the fee may be applied (e.g., if the average advance balance over prior 75 days was under $100 the fee might be $2, if the average advance balance over prior 75 days was between $100 and $250 the fee might be $5, etc.).

For each advance, the algorithm 2300 may determine which days represent 75, 150, 225 and 300 days after the advance has been created and ensures the periodic finance fee is assessed on each for each of those days and paid on the next pay date that is at least 14 days in the future (so the fee can, in practice, be reflected on the next statement). Note that the algorithm 2300 might not assess a periodic finance fee if the outstanding principal balance on the assessment date is $0 (regardless of whether there was a positive principal balance during the prior 75 days).

With these steps, the algorithm 2300 tracks outstanding principal balance for each day, and principal repayments, origination fees and periodic finance fees on the days they are due. In effect, the algorithm 2300 is maintaining a daily ledger for the employee given the specific input characteristics, the claims experience, and the credit limit.

Next, the algorithm 2300 may evaluate expected losses or gains at 2350. As used herein, the term “gains,” or net cash, may represent the total of origination fees and periodic finance fees minus the cost of capital minus expected losses from scheduled repayments that do not occur. If the system collects payments through paycheck deductions, for all practical purposes, the only way that losses can occur is if an employee terminates with an outstanding principal balance. To model potential losses, the algorithm 2300 may consider the probability that an employee terminates on any given day, and the implications on that termination on expected recovery of outstanding principal.

This section of the algorithm 2300 may begin by calculating a probability that the employee remains employed at the start of each day and the probability that the employee terminates on that day. These calculations can be thought of as binary, with the probability that the employee terminates on any day equaling:

(1+monthly turnover rate)^{1/30}

That probability of termination is reduced each day by 0.01%, reflecting the fact that, the longer an employee is employed, the more likely they are to stay employed. The probability that the employee remains employed at the start of any given day equals 1 minus the sum of probabilities of termination on all previous days.

For each day, the expected advances, principal repayments, origination fees and periodic finance fees equal those numbers (as calculated in the first part of the algorithm 2300) times the probability that the employee remains employed on that day. For example, if a $100 principal payment is due on a day when the expected probability of the employee remaining employed is 90% day, the expected principal repayment on that day will be $90. The same logic applies to all payments due on any given day. In addition, if the employee terminates on a given day, the system may expect to recover some or all of the principal balance owed from the next paycheck. The expected recovery from a final paycheck on any given day will be the amount that we can recover from the final paycheck times the probability that the employee terminates on that day. To summarize, the formula for net cash on any given day is:

daily expected net cash=(P×E)+(F×U)

where P represents payments due on that day, E represents a probability that the employee remains employed through that day, F represents an amount that can be recovered from the final paycheck U represents a probability of termination on that day.

The expected loss on that day same day is:

daily expected loss=MINIMUM($0,C−O)×U

where: C represents a final paycheck amount, E represents an outstanding principal balance, and U represents a probability of termination on that day.

To calculate net cash, the system may sum the expected gains and losses on each of the 761 days and the subtract the sum of the cost of capital for each day. The cost of capital for each day equals the daily interest rate multiplied by the outstanding balance on that day.

To determine the credit limit for each employee, the algorithm 2300 may run this for each of, for example, one hundred different limits and picks the limit among those hundred that maximizes net cash. The algorithm 2300 can determine credit limits for an entire population of client employees by running, for example, one hundred potential limits and picking the limit that maximizes net cash for each employee.

FIG. 24 is an employee turnover algorithm 2400 according to some embodiments. Note that the primary factors that drive differences in credit limits (all else being equal) is salary and predicted turnover rate. Salary is supplied by employer clients with a high level of certainty, but turnover rate is something that may be derived for each individual. The turnover algorithm 2400 may, according to some embodiments, uniquely combine industry data from the Department of Labor (“DOL”) and a payroll processing company data to estimate a predicted turnover rate for each client employee.

The DOL has been tracking turnover rates for 23 industries through its Job Openings and Labor Turnover Survey (“JOLTS”) program. That information is downloadable and available to the general public. This data provides a reasonable baseline for turnover rates by industry. But it is also known that turnover rates vary significantly depending by tenure with the current employer. For example, in the construction industry, average monthly turnover rates for people with less than 4 years of tenure is 5.1% while monthly turnover rates for people with 20 years or more of tenure is 0.8%, a six-fold difference within that industry. Therefore, knowing only the industry turnover rate is insufficient to make turnover predictions at the individual level. Note that tenure categories may be divided into multiple categories, such as: less than 4 years, 4 to 6 years, 6 to 9 years, 9 to 12 years, and over 12 years.

At 2410, the turnover algorithm 2400 combines the two data sets to create a lookup table by industry and tenure that provides monthly turnover estimates for any individual employee. The first step is to broaden the tenure categories through extrapolation and interpolation. To do so, the system may assume the reported data represents the mid-point of the range—for example, the turnover rate reported for less than four years is assumed to be the turnover rate for someone with two years of tenure, the number reported for four to six years is assumed to be the turnover rate for someone with five years of tenure, etc. With those points established, the system can develop change rates per year for data between each point. For example, if the two year tenure rate is 5% and the five year tenure rate is 2%, then the rate of change per year of tenure is 1% and the assumed three year tenure rate becomes 4%, the assumed four year tenure rate becomes 3% (i.e., 5%, 4%, 3%, 2% for 2, 3, 4, and 5 years of tenure, respectively). The algorithm 2400 may use that same rate of change to get zero year and one year tenure (in this case 7% and 6% for zero and one year tenure, respectively). The system may use the same methodology to flesh-out tenure rates for every year from zero (which represents less than 12 months of tenure) to over 20 years of tenure. When this step is completed, 21 tenure-based monthly turnover rate estimates may be created for each of eight industry classifications.

At 2420, the algorithm 2400 may map the payroll processing company data to the DOL data. This may be done assigning each DOL industry classification to the payroll processing company industry classification that it most closely matches. With 2420 complete, there may be 21 tenure-based estimated monthly turnover rate estimates for all 23 industries in the DOL database (i.e., a lookup table that is 23 rows by 21 columns for a total of 483 monthly turnover estimates (of which 8×21 or 168 are unique points).

When the algorithm 2400 is run for new or prospective clients, the first step is to assign that client company to one of the 23 BOL industry classifications, which is typically a straightforward exercise completed by an experienced business professional. By this point, the client will have provided us a roster of employees that includes date of hire. With date of hire, we estimate tenure at the plan start date by calculating the number of days between hire date and plan start date and dividing that number by 365.25 to get tenure expressed in year. We then perform a simple lookup in which we match industry and tenure in the lookup table to find the unique cell that contains our monthly turnover rate estimate. That monthly turnover rate number, along with salary, become the primary inputs to a credit limit model.

Some embodiments may grant credit to people to pay for qualified medical expenditures (as defined by the IRS) without doing a credit check.

a. The system may go to market through employers and receive from employer's information on salary and date of hire.

b. The system converts date of hire to “tenure” and then convert tenure to a probability of termination based on industry data.

c. The system then sets credit limits by testing 100 different limits with a credit limit algorithm and picks the one that maximizes net cash.

Embodiments may administer the advance program by “stacking” accounts in a particular way: an advance account is set up as a “notional” account, which means it is only funded when used so unlike an HSA account, in which dollars have to be present to be spent, a notional account allows a limit to set, and dollars to be used and then reimbursed to account. To do this, the account may be based on an “HSA shell”—which means using a structure similar to that of an HSA, but without some of the typical reporting. The advance account is then stacked, so that transactions can process in a particular order. For example, the transactions may first process through the HSA and once those funds are exhausted, whatever's left is processed using advance notional dollars (up to the limit). Some embodiments may first process transactions through the advance account and then essentially reimburse the advance account with real dollars from the HSA if they exist (e.g., for a $1,000 transaction, if there is $200 in the HSA account, the system may process the entire $1,000 through the advance account first and then recover the $200 from the HSA account.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with some embodiments of the present invention (e.g., some of the information associated with the databases described herein may be combined or stored in external systems). Moreover, although some embodiments are focused on particular types of spending accounts, any of the embodiments described herein could be applied to other types of applications. Moreover, the displays shown herein are provided only as examples, and any other type of user interface could be implemented. Any of the embodiments described herein may provide a Pharmacy Benefit Manager (“PBM”) that lets employees purchase medicine through their employer. Moreover, embodiments might provide add-on services (e.g., diabetes management) and the most appropriate services might be automatically matched with members. In still other embodiments, a sweepstakes or lottery might be tied to an HSA, etc.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system associated with an enhanced Health Saving Account (“HSA”) offered by an employer to a plurality of employees, comprising:
a member data store containing information associated with the plurality of employees, including, for each employee, an employee identifier, a communication address,
and employment characteristics that were received from an employer human resources system; and
an advance limit calculation platform, coupled to the member data store, including:
a computer processor, and
computer memory, coupled to the computer processor, storing instructions that, when executed by the computer processor, cause the advance limit calculation platform to:
(i) access information in the member data store,
(ii) compute score information using a score model and turnover information,
(iii) automatically calculate, for each employee, an advance limit based on the computed score information and the employment characteristics, and
(iv) arrange to transmit, to each employee via the communication address and a distributed communication network, enhanced HSA information including the calculated advance limit.

2. The system of claim 1, wherein the turnover information is associated with at least one of: (i) an industry turnover rate, and (ii) a company turnover rate.

3. The system of claim 1, wherein the employment characteristics include at least one of: (i) tenure, and (ii) gender.

4. The system of claim 1, wherein the communication address is associated with at least one of: (i) an email address, (ii) a postal address, (iii) a telephone number, (iv) a text chat interface, and (v) a streaming video interface.

5. The system of claim 1, wherein the employment characteristics include at least one of: (i) employee salary information, (ii) household salary information, (iii) a date of hire, (iv) payroll deduction availability, (v) a number of dependents, (vi) employer policies and preferences, and (vii) governmental regulations.

6. The system of claim 1, wherein an employee is registered as a member of the enhanced HSA.

7. The system of claim 6, wherein an advance is automatically activated when a member pays an HSA qualified bill in excess of an accumulated savings in their account up to the advance limit for that member.

8. The system of claim 7, wherein the advance is automatically repaid in increments over a pre-determined time period.

9. The system of claim 7, wherein a pre-determined fee is charged in connection with the advance.

10. The system of claim 1, further comprising:
an HSA administration server, associated with a funding platform bank account to administer the enhanced HSA.

11. A computer-implemented method associated with an enhanced Health Saving Account (“HSA”) offered by an employer to a plurality of employees, comprising:
computing score information using a score model and turnover information, including an industry turnover rate and a company turnover rate;
accessing information in a member data store that contains information associated with the plurality of employees, including, for each employee, an employee identifier, a communication address, and employment characteristics that were received from an employer human resources system;
calculating, by a computer processor of an advance limit calculation platform for each employee, an advance limit based on the employment characteristics; and
arranging to transmit, to each employee via the communication address and a distributed communication network, enhanced HSA information including the calculated advance limit.

12. The method of claim 11, wherein the communication address is associated with at least one of: (i) an email address, (ii) a postal address, (iii) a telephone number, (iv) a text chat interface, and (v) a streaming video interface.

13. The method of claim 11, wherein the employment characteristics include at least one of: (i) employee salary information, (ii) household salary information, (iii) a date of hire, (iv) payroll deduction availability, (v) a number of dependents, (vi) employer policies and preferences, and (vii) governmental regulations.

14. The method of claim 11, wherein an employee is registered as a member of the enhanced HSA.

15. The method of claim 14, wherein an advance is automatically activated when a member pays an HSA qualified bill in excess of an accumulated savings in their account up to the advance limit for that member.

16. The method of claim 15, wherein the advance is automatically repaid in increments over a pre-determined time period.

17. The method of claim 15, wherein a pre-determined fee is charged in connection with the advance.

18. A non-transitory, computer-readable medium storing instructions, that, when executed by a processor, cause the processor to perform a method associated with an enhanced Health Saving Account (“HSA”) offered by an employer to a plurality of employees, the method comprising:
accessing information in a member data store that contains information associated with the plurality of employees, including, for each employee, an employee identifier, a communication address, and employment characteristics that were received from an employer human resources system;
calculating, by a computer processor of an advance limit calculation platform for each employee, an advance limit based on the employment characteristics;
arranging to transmit, to each employee via the communication address and a distributed communication network, enhanced HSA information including the calculated advance limit;
attempting to access HSA funds of a particular employee;
if sufficient HSA funds are not available, accessing a purse amount, associated with the calculated advance limit, of that particular employee.

19. The medium of claim 18, wherein the communication address is associated with at least one of: (i) an email address, (ii) a postal address, (iii) a telephone number, (iv) a text chat interface, and (v) a streaming video interface.

20. The medium of claim 18, wherein the employment characteristics include at least one of: (i) employee salary information, (ii) household salary information, (iii) a date of hire, (iv) payroll deduction availability, (v) a number of dependents, (vi) employer policies and preferences, and (vii) governmental regulations.

21. A system to grant a person credit, without doing a credit check, to pay for qualified medical expenditures of a Health Saving Account (“HSA”) offered by an employer to a plurality of employees, comprising:
an advance limit calculation platform, including:
a computer processor, and
computer memory, coupled to the computer processor, storing instructions that, when executed by the computer processor, cause the advance limit calculation platform to:
(i) receive from the employer information about the person's salary and date of hire,
(ii) convert the date of hire to a tenure value,
(iii) convert the tenure value to a probability of termination based on industry data,
(iv) test a plurality of different credit limits with a credit limit algorithm and pick the credit limit that maximizes net cash to the system, and
(v) stack accounts, including a notional advance account the HSA, such that if funds are in the HSA, a transaction is first processed through the advance account and funds are then recovered the HAS.
